(19) United States
(12) Patent Application Publication
(10) Pub. No.: US 2023/0214653 A1
(43) Pub. Date: Jul. 6, 2023

(54) NON-TRANSITORY COMPUTER-READABLE RECORDING MEDIUM, MACHINE LEARNING METHOD, AND INFORMATION PROCESSING DEVICE

(71) Applicant: FUJITSU LIMITED, Kawasaki-shi (JP)

(72) Inventors: Keizo KATO, Kawasaki (JP); Akira NAKAGAWA, Sagamihara (JP)

(73) Assignee: FUJITSU LIMITED, Kawasaki-shi (JP)

(21) Appl. No.: 18/120,566

(22) Filed: Mar. 13, 2023

Related U.S. Application Data
(63) Continuation of application No. PCT/JP2020/035857, filed on Sep. 23, 2020.

(51) Int. Cl. G06N 3/08; G06N 3/0455

(52) U.S. Cl. CPC G06N 3/08; G06N 3/0455

(57) ABSTRACT

The information processing device inputs data into a machine learning model, acquires a first value output from the machine learning model in response to the inputting, a second value output from the machine learning model based on a variable obtained by modifying a latent variable that is calculated by the machine learning model in response to the inputting, and information entropy of the latent variable, and trains the machine learning model based on the first value, the second value and the information entropy of the latent variable.

### CROSS-REFERENCE TO RELATED APPLICATION

This application is a continuation of International Application No. PCT/JP2020/035857, filed on Sep. 23, 2020, the entire contents of which are incorporated herein by reference.

### FIELD

The embodiments discussed herein are related to the technology for machine learning.

### BACKGROUND

In data analysis, feature quantities (in the following explanation, sometimes referred to as “latent variables”) are extracted from complex multidimensional data such as images or sounds. In recent years, a technology is known in which the data is subjected to linear transformation and then independent component analysis (ICA) is performed to obtain the components that affect the data in an independent manner; and a technology is known in which, in combination with deep learning, the data is subjected to non-linear transformation and then ICA is performed. For example, related arts are disclosed in Patent Literature 1 Japanese Laid-open Patent Publication No. 08-305855 and Patent Literature 2 Japanese Laid-open Patent Publication No. 2019-139482

### SUMMARY

According to an aspect of an embodiment, a non-transitory computer-readable recording medium stores therein a program that causes a computer to execute a process. The process includes inputting data into a machine learning model, acquiring a first value output from the machine learning model in response to the inputting, a second value output from the machine learning model based on a variable obtained by modifying a latent variable that is calculated by the machine learning model in response to the inputting, and information entropy of the latent variable, and training the machine learning model based on the first value, the second value and the information entropy of the latent variable.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a functional configuration of an information processing device according to a first embodiment;

FIG. 2 is a diagram for explaining the machine learning of a machine learning model according to the first embodiment;

FIG. 3 is a flowchart for explaining the flow of a machine learning operation performed according to the first embodiment;

FIG. 4 is a diagram for explaining the machine learning of the machine learning model according to a second embodiment;

FIG. 5 is a diagram for explaining the machine learning of a machine learning model 14 performed according to a third embodiment; and

FIG. 6 is a diagram for explaining an exemplary hardware configuration.

### DESCRIPTION OF EMBODIMENTS

However, in the technologies mentioned above, it is difficult to perform independent component analysis of high-dimensional data. For example, if the network used in deep learning is of bijective nature, then it is not possible to perform dimensional compression. For that reason, even if independent components are obtained from high-dimensional data such as images or sounds, interpretation of those components remains a difficult task.

Preferred embodiments will be explained with reference to accompanying drawings. However, the present invention is not limited by the embodiments. Moreover, the embodiments can be appropriately combined without causing any contradiction.

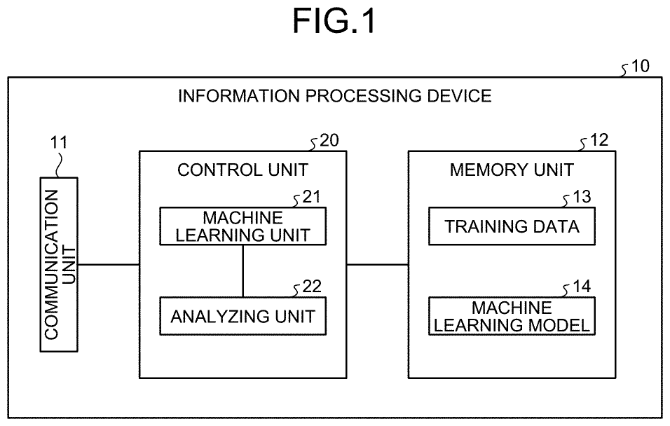

FIG. 1 is a block diagram illustrating a functional configuration of an information processing device 10 according to a first embodiment. The information processing device 10 illustrated in FIG. 1 extracts latent variables, which represent low-dimensional feature quantities, from complex multidimensional data; and performs data analysis. More particularly, the information processing device 10 trains a machine learning model using training data, and then performs ICA of the input data using the already-learnt machine learning model.

For example, the information processing device 10 trains a machine learning model based on, the value output by the machine learning model in response to the input of data, the value output by the machine learning model based on the variables obtained as a result of modifying the latent variables that are calculated by the machine learning model in response to the input of data, and the information entropy of the latent variables.

In the first embodiment, an autoencoder which represents an exemplary machine learning model having the rate distortion theory applied therein, is train by optimizing a cost function that is meant for minimizing the mutual information content of the latent variables. Then, high-dimensional data is input to the machine-learnt autoencoder, and the latent variables obtained in response to that input are used in performing ICA of the high-dimensional data. In the first embodiment, the explanation is given about the example in which machine learning and ICA is performed in the same device. However, that is not the only possible case. Alternatively, machine learning and ICA can be performed in separate devices.

As illustrated in FIG. 1, the information processing device 10 includes a communication unit 11, a memory unit 12, and a control unit 20. The communication unit 11 controls the communication with other devices. For example, the communication unit 11 receives various instructions, such as a machine learning start instruction, and target data for ICA from an administrator terminal; and sends the result of machine learning and the result of ICA to the administrator terminal.

The memory unit 12 is used to store a variety of data and to store programs to be executed by the control unit 20. For example, the memory unit 12 is used to store training data 13 and a machine learning model 14.

The training data 13 represents unsupervised training data that is used in the machine learning of the machine learning model 14. For example, depending on the target for ICA, high-dimensional data in the form of waveform data such as electroencephalographic data or electrocardiographic data, or image data capturing a person or an animal, or sound data can be used as the training data 13.

The machine learning model 14 is an autoencoder-based model generated by machine learning performed in the information processing device 10.

The control unit 20 is a processing unit that controls the entire information processing device 10, and includes a machine learning unit 21 and an analyzing unit 22. The machine learning unit 21 trains the machine learning model 14 using the training data 13.

More particularly, the machine learning unit 21 trains the machine learning model 14, which is an autoencoder including an encoder and a decoder, based on: the value output by the machine learning model 14 in response to the input of the training data 13; the value output from the machine learning model 14 based on the variables obtained by modifying the latent variables that are calculated by the machine learning model 14 in response to the input of the training data 13, and the information entropy of the latent variables.

For example, when time-series waveform data of the brain waves in which noise gets mixed at the time of measurement is input to the machine learning model 14, the machine learning unit 21 generates the machine learning model 14 for enabling accurate extraction of the feature quantities representing the features of an illness such as delirium or enabling accurate extraction of the feature quantities representing normal data. As another example, when face image data of a person is input to the machine learning model 14, the machine learning unit 21 generates the machine learning model 14 for enabling accurate extraction of the feature quantities of the eyes, the nose, and the mouth.

The analyzing unit 22 uses the machine-learnt machine learning model 14 and analyzes the target data for analysis. More particularly, using the machine-learnt machine learning model 14, the analyzing unit 22 extracts the feature quantities of the target data for analysis and performs analysis based on the extracted feature quantities. For example, the analyzing unit 22 extracts the feature quantities from the time-series waveform data of brain waves; compares the degree of similarity of the extracted feature quantities with the feature quantities of an illness; and detects the signs of that illness. Moreover, the analyzing unit 22 extracts the feature quantities from face image data; compares the degree of similarity of the extracted feature quantities with the feature quantities held in advance; and detects the gender or detects an unauthorized person.

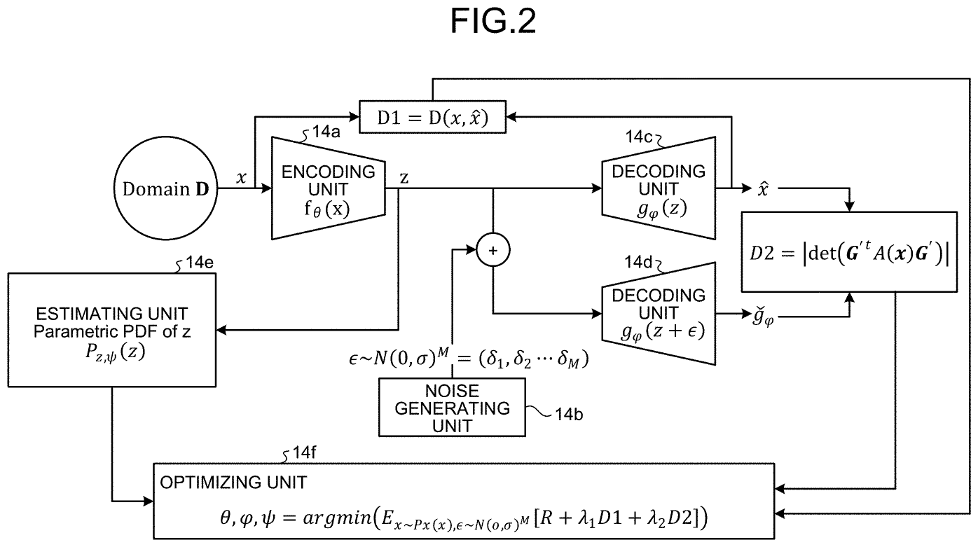

Given below is the specific explanation about the machine learning of the machine learning model 14. FIG. 2 is a diagram for explaining the machine learning of the machine learning model 14 performed according to the first embodiment. As illustrated in FIG. 2, the machine learning model 14 is an autoencoder that includes an encoding unit 14a, a noise generating unit 14b, a decoding unit 14c, a decoding unit 14d, an estimating unit 14e, and an optimizing unit 14f.

The encoding unit 14a uses a function f_{θ}(x) that has a parameter θ representing the target for machine learning, and encodes the input into a latent variable representing a low-dimensional feature quantity. For example, when training data x belonging to a domain D is input, the encoding unit 14a encodes the training data x and outputs a latent variable z. The noise generating unit 14b generates a noise ε that represents an N-dimensional uniform random number based on a distribution in which the dimensions do not have correlation with each other and which has the average “0”, and that conforms to the average “0” and a standard deviation σ.

The decoding unit 14c uses a function g_{ϕ}(z) that has a parameter ϕ representing the target for machine learning; and generates first-type reconfiguration data (x-hat) by decoding the latent variable z that is output from the encoding unit 14a. Moreover, the decoding unit 14d uses a function g_{ϕ}(z+ε) that has the parameter ϕ representing the target for machine learning, and generates second-type reconfiguration data (g_{ϕ}-check) by decoding the result of addition of the component of a specific dimension of the noise ε, which is generated by the noise generating unit 14b, to only a specific dimension of the latent variable z, which is output from the encoding unit 14a.

The estimating unit 14e uses a probability density function (PDF) that is a parameter ψ representing the target for machine learning; and estimates the latent variable z, which is output by the encoding unit 14a, as the probability distribution expressed using the parameter ψ.

The optimizing unit 14f optimizes the parameters θ, ϕ, and ψ by minimizing a first cost “D1”, a second cost “D2”, and a third cost “D3” from the autoencoder illustrated in FIG. 2.

The first cost “D1” is calculated using a difference “D1=D(x, x-hat)” between the training data x, which represents the input, and the first-type reconfiguration data (x-hat), which represents the output of the decoding unit 14c. The difference D(x, x-hat) is, for example, the square error between the training data x and the first-type reconfiguration data x-hat. Alternatively, any arbitrary error that enables approximation to Equation (1) can also be used. Herein, Δx represents an arbitrary microscopic displacement; and A(x) represents a matrix that defines the metric. Apart from the square error, examples of the error enabling approximation to Equation (1) also include structured similarity (SSIM) and binary cross entropy (BCE).

D(x,x+Δx)≃Δx^{t}A(x)Δx (1)

The second cost “D2” is defined using: a Jacobian matrix that is obtained by generating, for a number of times equal to the number of latent variables, the result of dividing the difference between the first-type reconfiguration data (x-hat), which represents the output of the decoding unit 14c, and the second-type reconfiguration data (g_{ϕ}-check), which represents the output of the decoding unit 14d, with a specific component of the noise; and a matrix that defines the metric.

More particularly, the second-type reconfiguration data (g_{ϕ}-check), which represents the output of the decoding unit 14d, is defined according to Equation (2) and using a micro-noise δᵢ with respect to the i-th component of the latent variable z. In Equation (2), δₘ represents an m-dimensional vector in which the m-th component is equal to & and other components are equal to “0”. If Equation (3) represents the result obtained when the difference between the output obtained by decoding the result of addition of the micro-noise δᵢ to the i-th component zᵢ of the latent variable z (i.e., the output representing the second-type reconfiguration data: g_{ϕ}-check) and the output of the decoding unit 14c (i.e., the output representing the first-type reconfiguration data: x-hat) is divided by the micro-noise δ_{I}; then a Jacobian matrix can be expressed using Equation (4). At that time, as the second cost “D2”, Equation (5) is defined in which a transpose (G′^{t}) of the Jacobian matrix, a matrix A(x) that defines the metric, and the Jacobian matrix (G′) are used. Herein, A(x) represents the matrix that defines the distance among sets of data. If that distance is defined using the square error, then the matrix A(x) becomes an identity matrix.

ĝ_{φ}=(g_{φ}(z+δ₁), . . . g_{φ}(z+δ_{M})) (2)

g′_{φ}_{ᵢ}=(\check{g}_{φi}−\hat{x})/δᵢ (3)

G′=(g′_{φ}_{₁},g′_{φ}_{₂},g′_{φ}_{₃}, . . . g′_{φ}_{ₘ}) (4)

D2=|det(G′^{t}A(x)G′)| (5)

The third cost “D3” is defined according to Equation (6) and as information entropy R of the latent variable. In Equation (6), a probability distribution “P_{z,ϕ}(z)” is assumed to satisfy Equation (7).

R=−log(P_{z,ψ}(z)) (6)

P_{z,ψ}(z)=Πᵢ₌₁^{N}P_{z}_{ᵢ}_{,ψ}(zᵢ) (7)

Using the first cost “D1”, the second cost “D2” and the third cost “D3=R” defined in the manner explained above, the optimizing unit 14f generates a learning cost “R+λ₁D1+λ₂D2”; trains to minimize the learning cost; and optimizes the parameters θ, ϕ, and ψ. Meanwhile, λ₁ and λ₂ represent weighting constants.

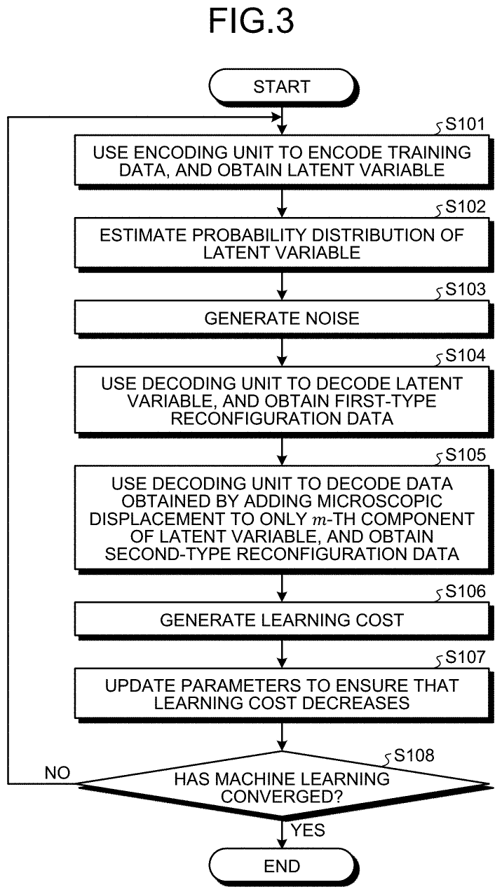

Given below is the specific explanation of a flow of operations explained above. FIG. 3 is a flowchart for explaining the flow of a machine learning operation performed according to the first embodiment. As illustrated in FIG. 3, the machine learning unit 21 uses the encoding unit 14a to encode the training data x that has been input, and obtains the latent variable z (S101).

Then, the machine learning unit 21 uses the estimating unit 14e to estimate the probability distribution P_{z,ϕ}(z) of the latent variable (S102). Moreover, the machine learning unit 21 uses the noise generating unit 14b to generate the noise ε (S103).

Subsequently, the machine learning unit 21 uses the decoding unit 14c to decode the latent variable z, and obtains the first-type reconfiguration data (S104). Moreover, the machine learning unit 21 uses the decoding unit 14d to decode the data obtained by adding the microscopic displacement δₘ to only the m-th component of the latent variable, and obtains the second-type reconfiguration data (S105).

Then, the machine learning unit 21 uses the optimizing unit 14f to generate the learning cost “R+λ₁D1+λ₂D2” using the first cost “D1”, the second cost “D2”, and the third cost “R” (S106); performs machine learning to minimize the learning cost; and optimizes the parameters θ, ϕ, and ψ (3107).

Subsequently, if the machine learning does not converge (No at S108), then the machine learning unit 21 performs the operations from S101 onward regarding the next set of training data. On the other hand, when the machine learning converges (Yes at S108), the machine learning unit 21 completes the machine learning of the machine learning model 14.

As a result of using the machine learning model 14 for analysis, it becomes possible to obtain the latent variables that have easily analyzable and easily interpretable characteristics and that serve as the result of independent component analysis with respect to the data.

More particularly, Equation (8) given below represents the product of the singular value of the transpose G′, and expresses the volume ratio of the data space and the latent space as well as expresses the ratio of the probability density of the data space and the latent space. That product is referred to as J_{SV}. Moreover, when L represents the cost function and when the training data x and the noise ε are as given in Equation (9), the expectation of the cost function L can be expressed using Equation (10) given below.

|det(G^{, t}A(x)G′)^{1/2} (8)

x˜Pₓ(x), ϵ˜N(O,σ) 9)

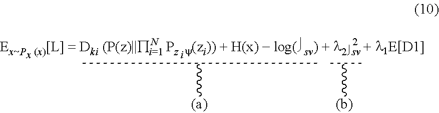

A term (a) in Equation (10) can be converted as given in Equation (11) because D_{Kl} represents Kullback-Leibler information (KL divergence) of P(z) and Equation (7), and because H(x) represents the information entropy of x and H(z) represents the information entropy of z. Moreover, a term (b) in Equation (10) can be calculated using Equation (12).

$${E}_{x ∼ {P}_{x} ( x )} [ R ] = \int p ( x ) {\prod }_{i = 1}^{N} {P}_{{z}_{i} , ψ} ( {z}_{i} ) dx = \int p ( z ) {J}_{sv}^{- 1} {\prod }_{i = 1}^{N} {P}_{{z}_{i} , ψ} ( {z}_{i} ) {J}_{sv} dz = {D}_{kl} ( P ( z ) \vert \vert {\prod }_{i = 1}^{N} {P}_{{z}_{i} , ψ} ( {z}_{i} ) ) + H ( z ) = {D}_{kl} ( P ( z ) \vert \vert {\prod }_{i = 1}^{N} {P}_{{z}_{i} , ψ} ( {z}_{i} ) ) + H ( x ) - log ( {J}_{sv} ) \qquad ( 11 )$$

$${λ}_{2} E [ D 2 ] ( {\vert det ( {{G}^{′}}^{t} A ( x ) {G}^{′} ) \vert}^{\frac{1}{2}} = {J}_{sv} \qquad ( 12 )$$

Herein, since λ₁E[D1] represents the reconfiguration error, it can be ignored when the machine learning has sufficiently progressed. Moreover, since H(x) is a constant number in “x˜Pₓ(x)”, it is not relevant to the minimization of the learning cost. Thus, when the first term of the cost function L is minimized, the latent variables become independent of each other. Meanwhile, if the condition for cost minimization is calculated by differentiation using the product J_{SV}, then the product J_{SV} becomes a constant number as given in Equation (13) as a result of modifying “0=(1/J_{SV})+2λ₂J_{SV}”.

$${J}_{sv} = \frac{1}{\sqrt{2 {λ}_{2}}} \qquad ( 13 )$$

That is, while the latent variables remain independent of each other, it becomes possible to perform analysis in which the probability of the latent space and the probability of the real space is maintained to be in a clear relationship of being a constant factor. Thus, for example, mutually independent latent variables can be extracted as feature quantities from the target electrocardiographic data for analysis, and are compared with the latent variables (feature quantities) of an illness. With that, the electrocardiographic data can be analyzed. Moreover, in the analysis of high-dimensional data, it is desirable that the analysis can be performed in a latent space subjected to low-dimensional compression. Moreover, in the analysis, it is desirable that the relationship between the obtained latent variables and the data is quantitatively interpretable.

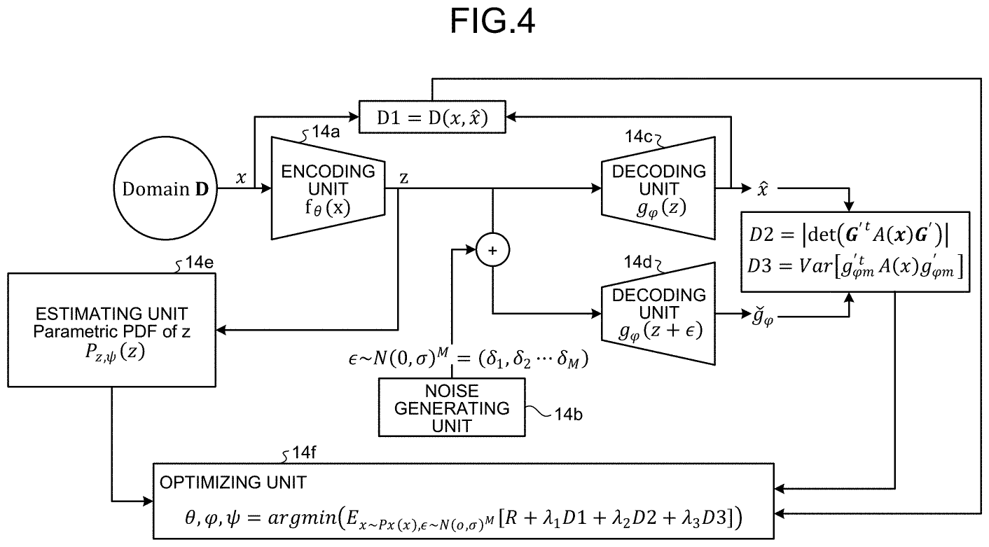

Regarding the machine learning of the machine learning model 14, given below is the explanation of a different embodiment than the first embodiment. FIG. 4 is a diagram for explaining the machine learning of the machine learning model 14 performed according to a second embodiment. The autoencoder illustrated in FIG. 4 has an identical configuration to the configuration of the autoencoder explained with reference to FIG. 2. Herein, the difference with FIG. 2 is that a new cost is added as part of the learning cost.

In an identical manner to FIG. 2, the first cost “D1” is calculated as “D1=D(x, x-hat)”. The second cost “D2” is calculated in the same manner as given earlier in Equation (5). The third cost is calculated using Equation (14) given below. The fourth cost is calculated in the same manner as given earlier in Equation (6).

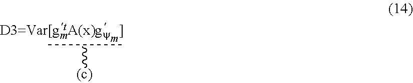

The third cost “D3” represents the dispersion of a term (c) in Equation (14), that is, represents the dispersion of the product of the transpose (g′^{t}) of each row element vector of the Jacobian matrix, the matrix A(x) that defines the metric, and the concerned row element vector (g′) of the Jacobian matrix. The machine learning unit 21 uses the first cost “D1”, the second cost “D2”, the third cost “D3”, and the fourth cost “D4=R” to generate a learning cost “R+λ₁D1+λ₂D2”; trains to minimize the learning cost; and optimizes the parameters θ, ϕ, and ψ. Meanwhile, each λ represents a weighting constant.

When the third cost “D3” is minimized as a result of performing machine learning, the impact of the microscopic displacement of each component of a latent variable on the data becomes constant. Hence, as explained in the first embodiment, while the latent variables remain independent of each other, it becomes possible to perform analysis in which the probability of the latent space and the probability of the real space is maintained to be in a clear relationship of being a constant factor. In addition, it becomes possible to perform analysis in which the impact of the microscopic displacement of each component of a latent variable on the data becomes constant.

For example, from a post-modification latent variable obtained by minutely modifying the latent variable of interest, electrocardiography data corresponding to the minute changes in the latent variable can be restored, so that it becomes possible to analyze the impact of the minute changes in the latent variable on the electrocardiography data. At that time, as a result of using the method according to the second embodiment, it becomes possible to hold down the impact of the latent variables other than the latent variable of interest. Hence, it becomes possible to restore electrocardiography data corresponding only to the minute changes in the latent variable of interest, thereby enabling achieving enhancement in the accuracy of the analysis.

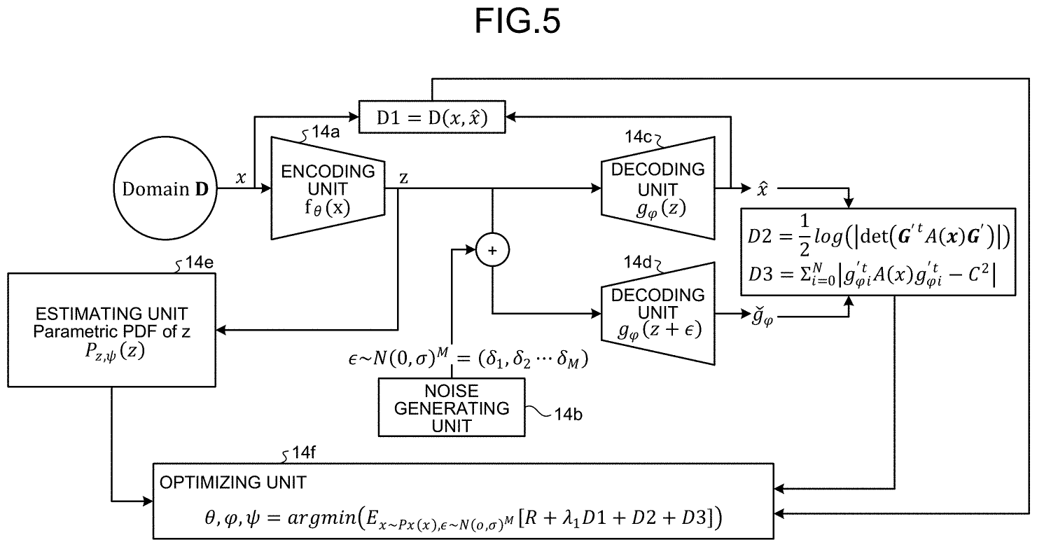

Given below is the explanation of the machine learning of the machine learning model that, while maintaining the independence of the latent variables, enables finding out the variables having a significant impact on the data. FIG. 5 is a diagram for explaining the machine learning of the machine learning model 14 performed according to a third embodiment. The autoencoder illustrated in FIG. 5 has an identical configuration to the configuration explained with reference to FIG. 2.

Herein, the difference with FIG. 2 is that four costs are used as part of the learning cost. In an identical manner to the first embodiment, the first cost “D1” is calculated as the error “D1=D(x, x-hat)” between the training data x, which represents the input data, and the first-type reconfiguration data (x-hat), which represents the output of the decoding unit 14c.

The second cost “D2” is calculated using the logarithm of the determinant of the product of: the transpose of a Jacobian matrix that is obtained by generating, for a number of times equal to the number of latent variables, the result of dividing the difference between the first-type reconfiguration data (x-hat) and the second-type reconfiguration data (g_{ϕ}-check) with a specific component of the noise; a matrix that defines the metric; and the Jacobian matrix. More particularly, using the micro-noise δᵢ with respect to the i-th component of the latent variable z, the second-type reconfiguration data (g_{ϕ}-check), which represents the output of the decoding unit 14d, is defined according to Equation (2) given earlier. Moreover, if Equation (3) given earlier represents the result obtained when the difference between the output obtained by decoding the result of addition of the micro-noise δᵢ to the i-th component zᵢ of the latent variable z (i.e., the output representing the second-type reconfiguration data g_{ϕ}-check) and the output of the decoding unit 14c (i.e., the output representing the first-type reconfiguration data x-hat) is divided by the micro-noise δᵢ, the Jacobian matrix can be expressed according to Equation (4) given earlier. At that time, as the second cost “D2”, Equation (15) given below is defined in which the logarithm of the determinant of the transpose (G′^{t}) of the Jacobian matrix is used, the matrix A(x) that defines the metric is used, and the Jacobian matrix (G′) is used.

$$D 2 = \frac{1}{2} log ( \vert det ( {{G}^{′}}^{t} A ( x ) {G}^{′} ) \vert ) \qquad ( 15 )$$

The third cost “D3” is calculated according to the sum of the values obtained by performing low-dimensional addition of the difference between the Hermitian inner product of each row element vector of the Jacobian matrix and the matrix that defines the metric, with a constant number. More particularly, as the third cost “D3”, Equation (16) given below is defined in which the product of the transpose (G′^{t}) of each row element vector of the Jacobian matrix, the matrix A(x) that defines the metric, and the concerned row element vector of the Jacobian matrix is used, and a constant number C is used. The fourth cost “D4=R” is defined as given earlier in Equation (6) in an identical manner to the third cost according to the first embodiment.

D3=Σᵢ₌₀^{N}|g′_{φ}_{ᵢ}^{t}A(x)g′_{φ}_{ᵢ}−C²| (16)

Then, the machine learning unit 21 uses the optimizing unit 14f to generate the learning cost “R+λ₁D1+λ₂D2+λ₃D3”; trains to minimize the learning cost; and optimizes the parameters θ, ϕ, and ψ. When the machine learning model 14 that is machine-learnt in the abovementioned manner is used in the analysis, the variables having a significant impact on the data can be found out while maintaining the independence of the latent variables.

More particularly, in an identical manner to the first embodiment, when L represents the cost function and when the training data x and the noise E are as given earlier in Equation (9), the expectation of the cost function L can be expressed using Equation (17) given below. Of Equation (17), terms (d) and (e) can be subjected to identical transformation to the transformation of the terms (a) and (b) of Equation (10) explained earlier in the first embodiment.

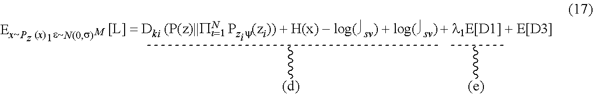

Herein, since λ₁E[D1] represents the reconfiguration error, it can be ignored when the machine learning has sufficiently progressed. Moreover, since H(x) is a constant number in “x˜Pₓ(x)”, it is not relevant to the minimization of the learning cost. Thus, when the first term of the cost function L is minimized, the latent variables become independent of each other.

The third cost “D3” given above in Equation (16) becomes the smallest when Equation (18) given below becomes equal to “0” regardless of the dimensionality. That is, in Equation (18), when a term (f), which represents the amount of displacement of the data when the latent variable of a particular dimension undergoes microscopic displacement, becomes equal to “C²”; the third cost “D3” given above in Equation (16) becomes the smallest.

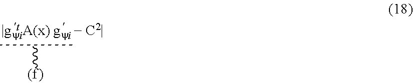

That is, it becomes possible to perform analysis in which, while the latent variables remain independent of each other, a clear relationship is maintained which indicates that the amount of displacement of the real data is constant regardless of the dimensionality when there is microscopic displacement of a particular latent variable. For that reason, the magnitude of dispersion of the latent variables can be mapped to the magnitude of the impact exerted on the data. Hence, the variables having a significant impact on the data can be found out while maintaining the independence of the latent variables.

Till now, the explanation was given about the embodiments of the present invention. However, apart from the embodiments described above, the present invention can also be implemented according to various other embodiments.

The numerical values used in the embodiments described above are only exemplary and can be changed in an arbitrary manner. Moreover, the machine learning model 14 that is machine-learnt according to the method explained above can be incorporated into an electroencephalograph, or an acoustic measurement device, or a camera; and the brain waveforms, or the speech waveforms, or the images obtained from such a device can be used in the analysis. Furthermore, the autoencoder too is not limited to have the configuration as explained in the embodiments, and the configuration can be changed in an arbitrary manner. Moreover, the machine learning model 14 is not limited to be an autoencoder. Alternatively, it is possible to use a model that calculates the latent variables from the training data, and generates a plurality of sets of reconfiguration data from the latent variables.

Meanwhile, in a standard equation, a vector is often written in boldface. However, in the equations given above, vectors are written in the same manner as the other characters. Such a manner of writing is because of the limitations of a written description, and it does not wrongfully limit the equations. For example, in the operations explained above, the input-output of data, the input-output of the encoder, and the input-output of the decoder represent the fundamental vectors; and a particular component of a vector is expressed as a scalar. Moreover, the expression of x-hat too is different than the expression used in a standard equation. Such an expression is used because of the limitations of a written description, and it does not wrongfully limit the equations.

The processing procedures, the control procedures, specific names, various data, and information including parameters described in the embodiments or illustrated in the drawings can be changed as required unless otherwise specified.

The constituent elements of the device illustrated in the drawings are merely conceptual, and need not be physically configured as illustrated. The constituent elements, as a whole or in part, can be separated or integrated either functionally or physically based on various types of loads or use conditions.

The process functions implemented in the device are entirely or partially implemented by a CPU or by programs that are analyzed and executed by a CPU, or are implemented as hardware by wired logic.

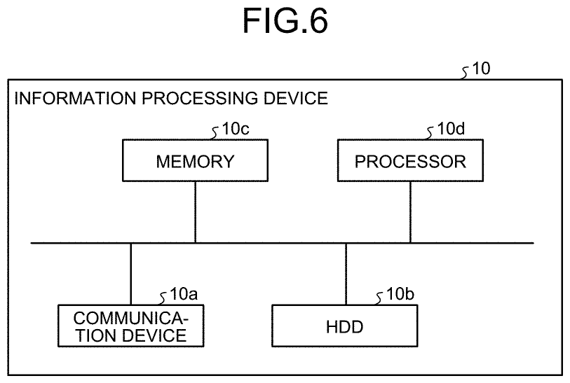

FIG. 6 is a diagram for explaining an exemplary hardware configuration. As illustrated in FIG. 6, the information processing device 10 includes a communication device 10a, a hard disk drive (HDD) 10b, a memory 10c, and a processor 10d. Moreover, the constituent elements illustrated in FIG. 6 are connected to each other by a bus.

The communication device 10a is a network interface card and performs communication with other devices. The HDD 10b is used to store programs meant for implementing the functions illustrated in FIG. 1, and to store databases.

The processor 10d reads, from the HDD 10b, a program meant for performing operations identical to the operations of the processing units illustrated in FIG. 1; loads the program in the memory 10c; and executes a process that implements the functions explained with reference to FIG. 1. For example, the process implements the functions identical to the processing units of the information processing device 10. More particularly, the processor 10d reads, from the HDD 10b, the program having functions identical to the machine learning unit 21 and the analyzing unit 22. Then, the processor 10d executes a processor that implements the operations identical to the machine learning unit 21 and the analyzing unit 22.

In this way, as a result of reading and executing a program, the information processing device 10 operates as an information processing device meant for implementing the machine learning method. Alternatively, the information processing device 10 can read the program from a recording medium using a medium reading device, and can execute the read program to implement the functions identical to the embodiments described above. Meanwhile, the program according to the other embodiments is not limited to be executed by the information processing device 10. Alternatively, for example, also when some other computer or some other server executes the program or when such other devices execute the program in cooperation, the present invention can still be implemented in an identical manner.

The program can be distributed via a network such as the Internet. Moreover, the program can be recorded in a computer-readable recording medium such as a hard disk, a flexible disk (FD), a CD-ROM, a magneto-optical disk (MO), or a digital versatile disc (DVD); and a computer can read the program from the recording medium and execute it.

According to an embodiment, independent component analysis of high-dimensional data can be performed in a low-dimensional space in which the interpretation is easier to perform.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
inputting data into a machine learning model;
acquiring a first value output from the machine learning model in response to the inputting, a second value output from the machine learning model based on a variable obtained by modifying a latent variable that is calculated by the machine learning model in response to the inputting, and information entropy of the latent variable; and
training the machine learning model based on the first value, the second value and the information entropy of the latent variable.

2. The non-transitory computer-readable recording medium according to claim 1, wherein
the machine learning model is an autoencoder that includes
an encoder having a first parameter,
an estimator having a second parameter, and
a decoder having a third parameter, and
the training includes optimizing the first parameter, the second parameter, and the third parameter so as to ensure minimization of
first-type reconfiguration data that is output from the decoder in response to the inputting,
second-type reconfiguration data that is output from the encoder based on a variable obtained by modifying a latent variable which is calculated by the encoder in response to the inputting, and
information entropy of the latent variable based on probability distribution of the latent variable as estimated by the estimator.

3. The non-transitory computer-readable recording medium according to claim 1, wherein
the machine learning model is an autoencoder configured to
encode the data and generates the latent variable, and
decode the data from the latent variable, and
the training includes
calculating a first cost based on difference between first-type reconfiguration data, which is obtained by decoding the latent variable, and the data,
calculating a second cost based on difference between second-type reconfiguration data, which is obtained by adding a noise to the latent variable, and the first-type reconfiguration data,
calculating, as a third cost, information entropy of the latent variable based on probability distribution of the latent variable, and
training the machine learning model to ensure minimization of the first cost, the second cost, and the third cost.

4. The non-transitory computer-readable recording medium according to claim 1, wherein
the machine learning model is an autoencoder configured to
encode the data and generates the latent variable, and
decode the data from the latent variable, and
the training includes
calculating a first cost based on difference between first-type reconfiguration data, which is obtained by decoding the latent variable, and the data,
calculating a second cost based on a Jacobian matrix in which a value is used that is obtained when difference between second-configuration data, which is obtained by decoding the latent variable after adding a noise thereto, and the first-type reconfiguration data is divided by a specific component of the noise,
calculating a third cost based on each row element vector of the Jacobian matrix,
calculating, as a fourth cost, information entropy of the latent variable based on probability distribution of the latent variable, and
training the machine learning model to ensure minimization of the first cost, the second cost, the third cost, and the fourth cost.

5. The non-transitory computer-readable recording medium according to claim 1, wherein
the machine learning model is an autoencoder configured to
encode the data and generates the latent variable, and
decode the data from the latent variable, and
the training includes
calculating a first cost based on difference between first-type reconfiguration data, which is obtained by decoding the latent variable, and the data,
calculating a second cost based on
Jacobian matrix in which a value is used that is obtained when difference between second-configuration data, which is obtained by decoding the latent variable after adding a noise thereto, and the first-type reconfiguration data is divided by a specific component of the noise, and
a matrix that defines measure,
calculating a third cost based on difference between
Hermitian inner product of each row element vector of the Jacobian matrix, the matrix that defines measure, and transpose of each row element vector of the Jacobian matrix, and
a constant number,
calculating, as a fourth cost, information entropy of the latent variable based on probability distribution of the latent variable, and
training the machine learning model to ensure minimization of the first cost, the second cost, the third cost, and the fourth cost.

6. A machine learning method comprising:
inputting data into a machine learning model;
acquiring a first value output from the a machine learning model in response to the inputting, a second value output from the machine learning model based on a variable obtained by modifying a latent variable that is calculated by the machine learning model in response to the inputting, and information entropy of the latent variable; and
training the machine learning model based on the first value, the second value and the information entropy of the latent variable, using a processor.

7. An information processing device comprising:
a memory; and
a processor coupled to the memory and configured to:
input data into a machine learning model;
acquire a first value output from the a machine learning model in response to input of the data, a second value output from the machine learning model based on a variable obtained by modifying a latent variable that is calculated by the machine learning model in response to input of the data, and information entropy of the latent variable, and
training the machine learning model based on the first value, the second value and the information entropy of the latent variable.
